(19) United States
(12) Patent Application Publication
(10) Pub. No.: US 2025/0071519 A1
(43) Pub. Date: Feb. 27, 2025

(54) CONNECTIVITY-AWARE ROBOT OPTIMIZATION IN MEC-ENABLED SCENARIOS

(71) Applicant: NEC Laboratories Europe GmbH, Heidelberg (DE)

(72) Inventors: Lanfranco ZANZI, Heidelberg (DE); Antonio ALBANESE, Heidelberg (DE); Xi LI, Heidelberg (DE)

(21) Appl. No.: 18/726,133

(22) PCT Filed: Mar. 28, 2022
(86) PCT No.: PCT/EP2022/058160

§ 371 Date: Jul. 2, 2024

(30) Foreign Application Priority Data
Jan. 12, 2022 (EP) 22151189.2

(51) Int. Cl. H04W 4/029; H04L 67/12; H04L 67/567

(52) U.S. Cl. CPC H04W 4/029; H04L 67/12; H04L 67/567

(57) ABSTRACT

A method of providing radio context map information to a Multi-Access Edge Computing (MEC) application that is deployed at a MEC host and manages a 5G or Beyond 5G (B5G)-enabled network device is provided. The method includes registering and running a Radio Context Map Service (RCMS), on an MEC platform of the MEC host. The RCMS subscribes to location and radio information from existing MEC services of the MEC platform. The RCMS creates and updates a radio context map by processing location and radio information received from the subscribed MEC services and by combining the received location and radio information with additional application related context information provided through the MEC application or any other MEC application deployed at the MEC host. The RCMS provides the radio context map to the MEC application.

### CROSS REFERENCE TO RELATED APPLICATIONS

This application is a U.S. National Phase application under 35 U.S.C. § 371 of International Application No. PCT/EP2022/058160, filed on Mar. 28, 2022, and claims benefit to European Patent Application No. 22151189.2, filed on Jan. 12, 2022. The International Application was published in English on Jul. 20, 2023 as WO 2023/134880 A1 under PCT Article 21(2).

### FIELD

The present invention relates to methods and systems for providing radio context map information to a Multi-Access Edge Computing, MEC, application that is deployed at a MEC host and manages a 5G or B5G (Beyond 5G)-enabled network device.

### BACKGROUND

Many applications that control or manage 5G-enabled network devices might take advantage of network coverage and radio context map information. For instance, in robotics scenarios, simultaneous localization and mapping (SLAM) is an application that aims at estimating the position of a robot and the characteristics of the environment at the same time, i.e., inferring the relative robot location given a map of the environment while building a map of the environment given a set of measurements taken at subsequent robot locations. SLAM is considered fundamental for robots to become truly autonomous as it enables motion, navigation and path planning based on robots localization information, in order to, e.g., avoid obstacles or minimize the energy consumption via shortest path selection. The measurements are traditionally tackled by means of multiple sensors, such as video cameras, lidar, radar, tactile sensors, which are however highly computationally expensive and require the robot, due to its limited energy and computing resources, to stream (off-load) the sensor data to external computing facilities and retrieve only the outcome of the related computations, i.e. a 2D/3D map of the surrounding environment.

Given the effort in building knowledge about an unknown environment, it is fundamental to ensure computational efficiency by sharing the information gained by each robot with others in the same dissemination area as to enhance their context-awareness, e.g. detected obstacles. Indeed, this would allow other robots to save time and resources by avoiding cold-start exploration tasks and, at the same time, the information collected by multiple robots may be merged to update the past information or build a more comprehensive (aggregated) environment map.

Indoor moving robots are traditionally controlled by means of local wireless networks (WLAN), e.g., WiFi, Bluetooth. Nevertheless, in outdoor scenarios WLAN connectivity is not always available, and requires the setup of costly ad-hoc networks to ensure connectivity between the operator's controller (which may be human or application-based) and the robot. In this scenario, thanks to their low-latency and almost ubiquitous coverage, mobile networks (5G or B5G) may be exploited to send control messages toward the robot devices. In the context of 5G-and-beyond networks, a Multi-access Edge Computing (MEC) platform may also be adopted as edge computation platform to host robotic application and SLAM services and allow robots to offload the heavy computation task demanded by these applications, returning to the robots the output of the computation, i.e. the current spatial map of the environment.

Robots performing the SLAM task (or any other tasks involving the exploration of an area) would benefit from good wireless propagation conditions, which ensure faster and more resilient upload of the collected sensor information, as well as saving the energy needed for transmitting data in poor channel conditions or re-transmitting in case of a link drop. Thus, it will be helpful for the robotic applications to get, in a pro-active manner, information about the expected channel conditions in a geographical area. However, the robots have currently no direct means to acquire such RAN coverage information within the robotic domain, which can be essential to plan the device navigation path while guaranteeing adequate levels of channel quality and minimizing the risk of disconnection.

A comprehensive RAN coverage map of an area of interest requires location (with respect to a relative reference point, or absolute) and channel information at once. Although robots' absolute location in outdoor scenarios can be obtained by means of Global Navigation Satellite Systems (GNSSs), e.g. GPS, satellite signals are mostly blocked during indoor operations thus requiring falling back on network-based solutions such as WiFi fingerprinting. Alternatively, advanced cellular-based localization solutions enabled by large antenna arrays and high bandwidth can be adopted to localize robots within the coverage area of one or more base stations.

In this context, the system disclosed in U.S. Pat. No. 9,080,889 B2 provides a wireless device with a route along which is guaranteed to experience wireless coverage for a given percentage of the route by processing past wireless session records on demand, i.e., upon the incoming request by the wireless device. This solution has a rigid data structure that does not allow collecting and sharing numerical radio network information such as SINR, RSRP, RSRQ, nor accounting for additional device-related metrics that might be dynamically added to the map. Additionally, it lacks real-time collection, update and distribution among heterogeneous parties requesting such features to perform smart and time-critical operations.

Besides, EP 3 010 274 A1 discloses a procedure to build a coverage map within a telecommunication network, which is purely limited to collecting and aggregating measurements from wireless devices in a central storage node. Such information is limited to power measurements only, and not redistributed or made accessible to 3rd-parties, serving the only purpose of offline network optimization and planning.

Therefore, with the rising interest in time-sensitive operations, more and more applications might take advantage of coverage map information, which are currently not accessible at the network edge.

### SUMMARY

In an embodiment, the present disclosure provides a method of providing radio context map information to a Multi-Access Edge Computing (MEC) application that is deployed at a MEC host and manages a 5G or Beyond 5G (B5G)-enabled network device, the method comprising: registering and running a Radio Context Map Service (RCMS), on an MEC platform of the MEC host; subscribing, by the RCMS, to location and radio information from existing MEC services of the MEC platform; creating and updating, by the RCMS, a radio context map by processing location and radio information received from the subscribed MEC services and by combining the received location and radio information with additional application related context information provided through the MEC application or any other MEC application deployed at the MEC host; and providing, by the RCMS, the radio context map to the MEC application.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating an overall system architecture of a system for building a radio context map in accordance with an embodiment of the present invention;

FIG. 2 is a schematic view illustrating a functional system architecture of a system for building a radio context map in accordance with an embodiment of the present invention;

FIG. 3 is a message flow diagram illustrating a coverage map request procedure in accordance with an embodiment of the present invention;

FIG. 4 is a schematic view illustrating a simple definition of a coverage radio context map in accordance with an embodiment of the present invention;

FIG. 5 is a message flow diagram illustrating a radio context map creation procedure based only on network-originated information in accordance with an embodiment of the present invention; and

FIG. 6 is a message flow diagram illustrating a radio context map creation and update procedure including robot-originated metrics in accordance with an embodiment of the present invention.

### DETAILED DESCRIPTION

The project leading to this patent application has received funding from the European Union's Horizon 2020 research and innovation programme under grant agreement No 101016681.

In accordance with an embodiment, the present invention improves and further develops a method and a system of the initially described type for providing radio context map information to a MEC application deployed at a MEC host and managing a 5G or B5G (Beyond 5G)-enabled network device in such a way that comprehensive radio network related updated information can be provided in an efficient and reliable way in order to enable the MEC applications to perform smart and time-critical operations.

In accordance with another embodiment, the present invention provides a method of providing radio context map information to a Multi-Access Edge Computing, MEC, application that is deployed at a MEC host and manages a 5G-enabled network device, the method comprising: registering and running a Radio Context Map Service, RCMS, on the MEC platform of the MEC host; subscribing, by the RCMS, to location and radio information from existing MEC services of the MEC platform; creating and updating, by the RCMS, a radio context map by processing location and radio information received from the subscribed MEC services and by combining this information with additional application related context information provided through the MEC application or any other MEC application deployed at the MEC host; and providing, by the RCMS, the radio context map to the MEC application.

Furthermore, in accordance with another embodiment, the present invention provides a system for providing radio context map information to a Multi-Access Edge Computing, MEC, application that is deployed at a MEC host and manages a 5G or B5G (Beyond 5G)-enabled network device, the system comprising a Radio Context Map Service, RCMS, registered at and running on the MEC platform of the MEC host, the RCMS being configured to subscribe to location and radio information from existing MEC services of the MEC platform, to generate and update a radio context map by processing location and radio information received from the subscribed MEC services and by combining this information with additional application related context information provided through the MEC application or any other MEC application deployed at the MEC host, and to provide the radio context map to the MEC application.

According to embodiments, the present invention provides a system to build a radio context map service on a MEC platform, to provide up-to-date radio related information to smart mobile devices (e.g., robots, drones, etc.) or to a group of vehicles (e.g., automotive cars) relying on cellular communications in an area. Such information can be used as input for a device control system to control the devices and orchestrate the resources that may be required in a smart way. Embodiments of the invention provide methods and data models to collect and process information from various existing network services (e.g., radio quality, localization, etc.), as well as real-time information coming from device applications, to create and continuously update a radio context map.

It is important to note that the proposed RCMS is a novel MEC service not existing in today's deployments. According to embodiments of the invention, the RCMS will run within a MEC host, and could provide the radio context map information to any other MEC application. In other words, RCMS's context map information can be generally offered to other MEC applications running within the same host, or even other MEC services.

In the context of the present disclosure, the term ‘coverage’ is generally to be understood to refer to radio and spatial information, whereas the term ‘context’ is to be understood to refer to application related context information, in particular application KPIs (Key Performance Indicators) and QoE (Quality of Experience) metrics, provided by the MEC application instances running on the respective MEC host.

As an advantage, embodiments of the invention allow new robotic deployments, accessing through the same set of base stations and MEC platform, to inherit the coverage map information and perform pro-active optimization steps into e.g., motion planning and advanced traffic off-loading procedures. Good channel conditions enable faster and more energy efficient information sharing, as well as timely transmission/reception of data which is particularly important in latency constrained applications. In case of poor channel conditions, robots may use additional transmission energy to achieve the desired throughput. To avoid this occurrence on energy-constrained devices, often robot sensors data are locally stored (in a local storage system) and later uploaded to the computing platform. As will be easily appreciated, however, this is feasible only in use-cases that are not time-sensitive.

It should be noted that, generally, there are other ways to obtain localization information in 3GPP mobile networks, for example the 4G G-SMLC or the 5G LMF. This approach however implies direct communication with the 4G MME and/or 5G AMF, which are generally located in the core of the network. This has significant consequences on the message exchange latency and impacts on the accuracy of the coverage map information.

An up-to-date information about the quality of the radio channels is a useful information for the robotic applications at the Robot Control System level, since it would allow to pro-actively make orchestration decisions impacting on the robot device energy consumption and other aspects of its operational phase. Currently, such information can also be obtained by dedicated measurement procedures done at application level, performed on ongoing and already established communication sessions. This however does not exploit public mobile networks but dedicated local area networks (Generally WiFi). Moreover, the measurement campaign in generally done over short time intervals, therefore providing poor confidence on the collected information for subsequent reuse of the information.

According to an embodiment of the present invention, the MEC application is a Robot Control System, RCS, configured to manage operation of a 5G-or B5G-enabled robot device. As will be appreciated by those skilled in the art, apart from such robotic use cases, further use cases and scenarios can be easily envisioned, e.g. in the field of connected vehicles. In other words, the robotic use cases described herein, where the RCS is controlling a number of 5G/B5G-enabled robot device in a 5G/B5G mobile network, can be extended to a general case where an MEC application manages a number of user devices with on-board sensors and network connectivity to a mobile network (e.g. 4G, 5G, B5G, etc.) infrastructure within coverage of the MEC host.

According to an embodiment, it may be provided that the radio context map is shared with other MEC applications running on the same MEC host. In particular, it may be provided that, leveraging on the Mp2 interface, the RCMS may share with RCS or any other third party applications (MEC Apps) and offer them use-case specific Radio Map Information to perform more accurate and optimized decisions based on such added-value information. In fact, sharing the information gained by each MEC applications enhances the computational efficiency of the device is controlled by the MEC applications, e.g. robots devices, since it enhances the robots' context awareness and allows them to avoid cold-start exploration tasks, thereby saving time and resources.

According to an embodiment, the existing MEC services of the MEC platform to which the RCMS subscribes in order to retrieve location and radio information from these services may include the MEC Radio Network Information Service, RNIS, and/or from the MEC Location Service; MEC LS.

A list of available information that may be retrieved through the RNIS service includes, for instance:
measurement information related to the user plane (based on 3GPP specifications), e.g., real-time radio network conditions such as SINR, RSRP, RSRQ, etc.;
information related to specific UEs connected to the radio node(s) associated with the MEC host, e.g., their UE context and the related radio access bearers; and/or
changes on information related to UEs connected to the radio node(s) associated with the MEC host, their UE context and the related radio access bearers. Among the supported location information, the LS may provide, for instance:
the position of BSs in the scope (i.e., associated) of the current MEC host;
the position of UEs connected by the BSs in the scope of the current MEC host; and/or
a list of UEs located in or moving to/from a particular geographical area.

According to an embodiment of the invention, the RCMS may be configured to create and update the radio context map by additionally including information collected locally via on-board sensors by the 5G or B5G-enabled network devices itself and/or by further 5G/B5G-enabled network devices deployed in the coverage area of the radio nodes associated with the MEC host. More specifically, it may be provided that the RCMS is configured to combine and map the RAN measurement reports and location information of the UEs in this area, leveraging on the information provided by other available MEC services (e.g., RNIS and LS services) and/or robotic applications (e.g., QoE-related information, GPS, etc.) and to process them to build a consolidated RAN context map in a user-transparent way.

According to an embodiment of the invention, the RCMS may be configured to store a collected set of historical real-time RAN information (such as coverage, channel quality, etc.) over a specified time period in a geographical area including a set of radio nodes from one or multiple operators or organizations associated with the same MEC host.

According to an embodiment of the invention, the MEC application, e.g. the RCS, may use the radio context map to generate and send via an existing mobile network communication channel appropriate control instructions to the 5G-enabled network device managed by the MEC application, e.g. a robot device.

According to an embodiment of the invention, connectivity between the 5G-enabled network device and the MEC application may be provided by the 5G network data plane exploiting a dedicated User Plane Function, UPF, deployed within the MEC system. Specifically, the UPF may act as PDU session end-point for the mobile tunneling protocol (GTP protocol). Instance(s) of the MEC application may run as Virtual Machines (VMs)/Containers within the MEC platform, wherein each instance may comprise multiple modules that allow to extend the capabilities of the controlled network device and to offload heavy computational tasks to the edge computing platform, e.g. to save energy in the robots, and achieve faster processing of streaming information.

There are several ways how to design and further develop the teaching of the present invention in an advantageous way. To this end, it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained. In the drawing

In the robotic domain, the Robot Control System (RCS) is in charge of managing all the aspects related to robot devices, e.g., robot navigation planning, energy management, sensor activation. Currently, it has no means to access radio context information which may help performing robot orchestration tasks more accurately. This results in sub-optimal decisions with negative effects on robot energy consumption and task execution. Especially, in collaborated connected robot scenarios, sharing such radio related information can be helpful to optimize the decision on the movements and actions of multiple robots exploring in the same area to coordinate their tasks. For instance, the robots experiencing poor channel conditions can rely on the robots with good radio condition to perform the tasks that may require high-quality data transmissions, so as to save energy and resources on the robots.

Embodiments of the present invention address this issue by enabling access to up-to-date radio context map information at the edge while providing a way to seamlessly incorporate device-related metrics whenever available. More specifically, embodiments of the present invention enable robot control systems managing robot devices deployed in unknown radio environments to obtain RAN coverage map information, including the expected channel conditions at all available locations in the area covered by the set of serving (and neighbor) base station, which is a crucial information to effectively plan the robot tasks (for example, but not limited to, navigation and offloading tasks) and enhance the robots efficiency (in terms of energy and resources usage) and task performance (e.g. reduction of the task execution time) during their operations.

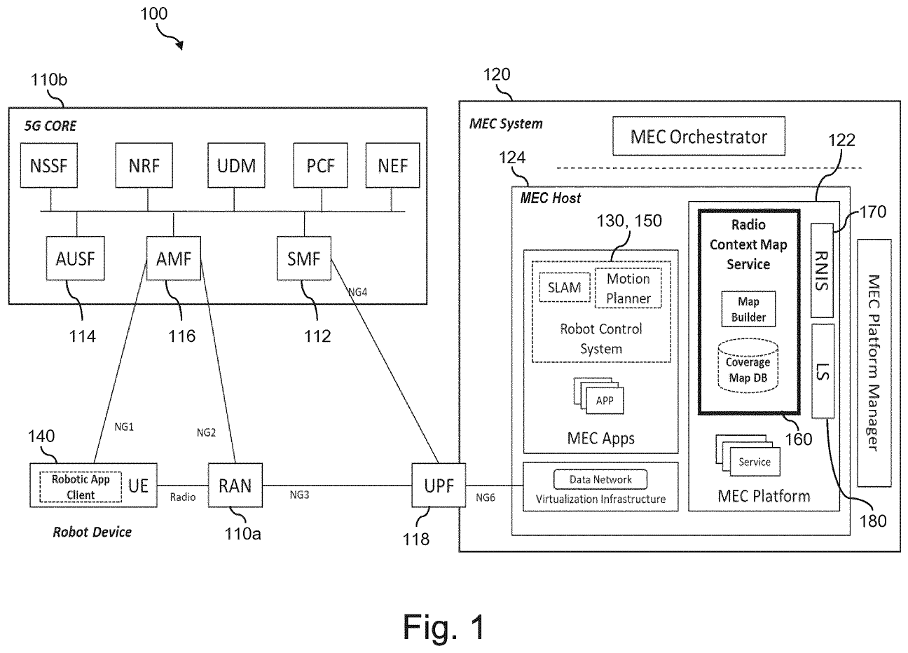

Embodiments of the present invention provide a system that builds and distributes a radio context map of a target area by combining information collected by previously and concurrently deployed robots in the respective target area with information provided by the cellular network. FIG. 1 depicts a reference high-level architecture of a system 100 in accordance with an embodiment of the invention, which comprises a 5G network 110 (including RAN 110a, core 110b and transport network 100c) and an MEC system 120 including an MEC platform 122, as well as a robotic application 130 managing 5G-enabled remotely-controlled robots 140 and their respective functionalities (like sensing, navigation, etc.). The MEC platform 122 may be implemented based on the ETSI MEC standard (for reference, see ETSI GS MEC 012 V2.1.1 (2019-12) Multi-access Edge Computing (MEC); Radio Network Information API, and ETSI GS MEC 013 V2.1.1 (2019-09) Multi-access Edge Computing (MEC); Location API, both documents being hereby incorporated by reference herein).

The 5G network 110 includes control plane functionalities such as routing, authentication and mobility management by means of standardized entities such as SMF (Session Management Function) 112, AUSF (Authentication Server Function) 114 and AMF (Access and Mobility Management Function) 116. While the exact positioning of these functionalities is out of the scope of the present disclosure, embodiments of the present invention assume that the robot applications 130 are deployed as virtual/container-based images at the MEC host 124, within the MEC platform 122 premises. By running the robot applications 130 as MEC applications at the edge of the network 110, the system 100 ensures low latency (due to proximity), high bandwidth and exposure to location and up-to-date radio network information.

Connectivity between the User Equipment (UE) (for instance, robot device 140 in accordance with embodiments of the present invention) and the robot control system, RCS 150, with defined control logic, is provided by the 5G network data plane exploiting a dedicated User Plane Function, UPF 118, deployed within the MEC premises, which acts as PDU session end-point for the mobile tunnelling protocol (GTP protocol). Given the above, instance(s) of the RCS 150 are assume to run as Virtual Machines (VMs)/Containers within the MEC platform 122. Each RCS instance may be composed of multiple modules, allowing to extend the robot capabilities and offload heavy computational tasks to the edge computing platform, e.g. to save energy in the robots, and achieve faster processing of streaming information.

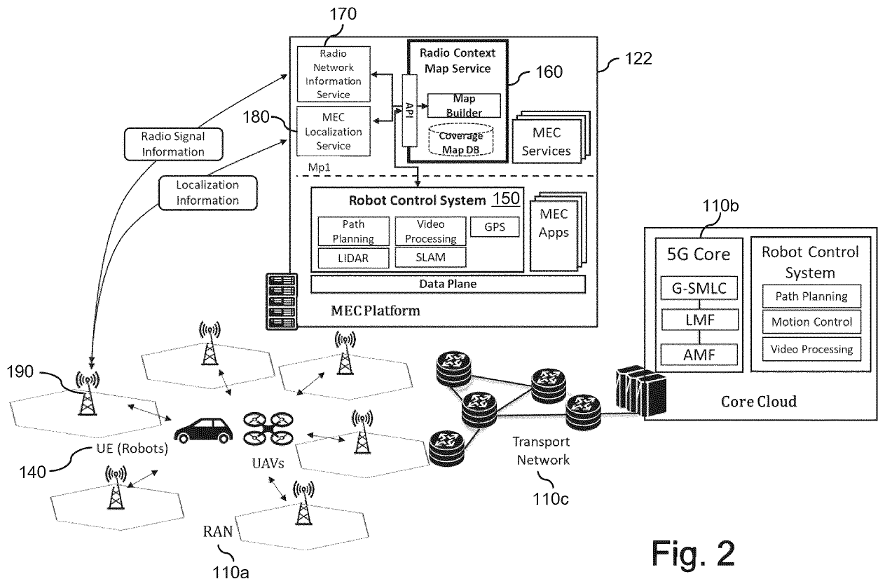

In this context, as shown also in FIG. 2, embodiments of the present invention introduce a novel service, herein referred to as Radio Context Map Service, RCMS 160, which is in charge of building (and sharing) the RAN Coverage Map information to robots joining/moving under the coverage area provided by a set of base stations connected to the same MEC host 124.

According to embodiments of the invention, the RCMS 160 may be configured to compute a RAN coverage map by means of mobile network-based information, as well as other possibly available sensor data provided by the robot application 130, e.g. RCS 150, running within the MEC platform 122. Specifically, the RCMS 160 may retrieve the network-based information through the following already available MEC services: the Radio Network Information Service, RNIS 170, and the MEC Location Service, MEC LS 180. In the following, a brief overview of such services will be provided, highlighting their role and limitations in the context of the present invention.

MEC RNIS. ETSI defines the Radio Network Information Service (RNIS) as a service that provides radio network related information to MEC applications and to MEC platforms, making MEC platform 122 deployed at the network edge the most suitable network framework option in the context of the present invention (cf. ETSI GS MEC 012 V2.1.1 (2019-12) Multi-access Edge Computing (MEC); Radio Network Information API). In accordance with embodiments of the invention, the RNI service 170 is envisioned as a suitable mean to obtain channel quality information in real-time. The spatial granularity of the radio network information may be adjusted on a cell, UE or QoS Class Identifier (QCI) basis. Information retrieved through RNIS 170 may include, but not limited to, measurement information related to the user plane, information related to specific UEs 140 connected to the radio node(s) 190 associated with the MEC host 124, and/or changes on information related to UEs 140 connected to the radio node(s) 190 associated with the MEC host 124, their UE context and the related radio access bearers. It should be noted, however, that the information above can be retrieved only as a consequence of a selected set of triggering events, and that currently there are no means for on-demand and continuous update requests.

Mobile Edge LS. The Mobile Edge Location Service, MEC LS, provides location-related information to the MEC platform as well as to other MEC applications (cf. ETSI GS MEC 013 V2.1.1 (2019-09) Multi-access Edge Computing (MEC); Location API). In accordance with embodiments of the invention, the MEC LS 180 is used to n provide information including, but not limited to, the position of BSs 190 in the scope (i.e., associated) of the current MEC host 124, the position of UEs 140 connected by the BSs 190 in the scope of the current MEC host 124, and/or a list of UEs 140 located in or moving to/from a particular geographical area.

In accordance with the embodiment of the invention, the LS 180 can be provided by different modern approaches. For instance, 3GPP Release 16 may require horizontal and vertical positioning error smaller than 3 m for 80% of User Equipments (UEs) in indoor deployment scenarios, which is theoretically obtainable by means of Downlink-Time Difference of Arrival (DL-TDoA) techniques (cf. R. Keating, M. Saily, J. Hulkkonen, and J. Karjalainen, “Overview of positioning in 5G new radio,” in International Symposium on Wireless Communication Systems (ISWCS), 2019, pp. 320-324). However, Beyond 5G (B5G) networks starting with 3GPP Release 17 promise to raise the bar and continue shrinking the localization error in order to achieve sub-cm accuracy. Massive multi-input-multi-output (MIMO), millimeter wave (mmWave), ultra-dense networks (UDNs) and device-to-device (D2D) communication are the pillars of such improvement together with fusing the data coming from radio access technology (RAT)-independent localization, such as proximity-based techniques (cf. Xiao, Z. and Zeng, Y., “An Overview on Integrated Localization and Communication Towards 6G”, arXiv e-prints, 2020).

### Radio Context Map Distribution

A radio context map can be built by iteratively measuring the radio quality along the robots' 140 motion paths, either actively via dedicated sensors or concurrently with the uplink stream of sensor data (data plane transmission).

According to an embodiment of the invention, the Robot Control System, RCS 150, may be configured to leverage the existing MEC architecture and the Radio Context Map Service as disclosed herein to acquire RAN coverage information. This would enable more accurate optimization decision-making in the context of robot path navigation and task offload.

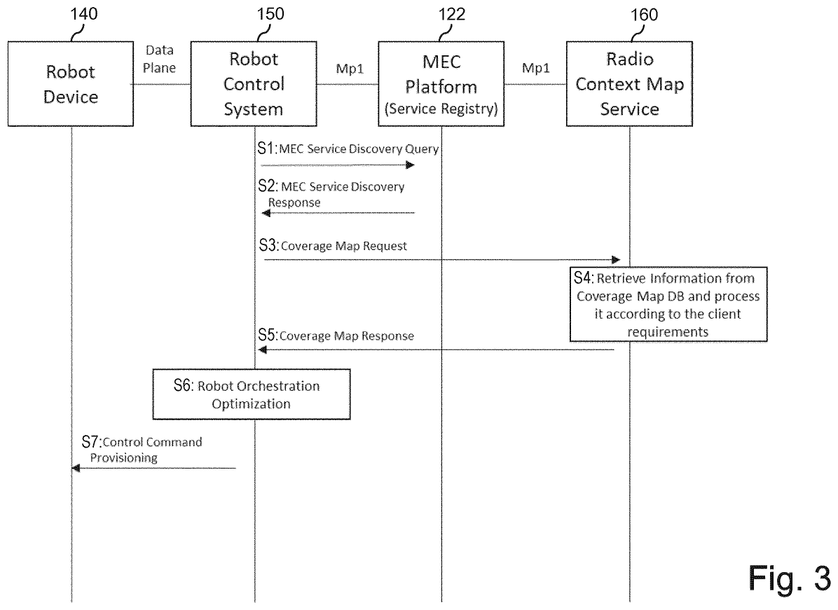

An embodiment of a coverage map request procedure for a robot device 140 is exemplary illustrated in FIG. 3. As shown at step S1, the robot device's 140 RCS 150 running within the MEC host 124 queries the MEC platform 122 (via the Mp1 interface) to discover the available MEC Services. In response to this query and as shown at step S2, the RCS 150 gets the list of available MEC services. According to an embodiment of the invention, the list includes the novel Radio Context Map Service (RCMS) 160 as disclosed herein.

After having received the list of available MEC services, the RCS 150 sends a Coverage Map request message to the Radio Context Map Service 160, as shown at step S3. In embodiments, the request may include one or more of the attributes shown in Table 1 below.

TABLE 1
Query message attributes to obtain a Radio Context Map

| Attribute name | Qualifier | Cardinality | Data type | Description |
|---|---|---|---|---|
| RequesterID | M | 0 . . . N | URI | ID of the Robot Control System |
| | | | | requesting the service |
| RequestID | M | 0 . . . N | Enumeration | ID of the request. |
| EnableAccess | M | 1 | Binary | Defines if the Robot Control System |
| | | | | offers access to the Coverage Map |
| | | | | Service with additional application |
| | | | | specific metrics and information |
| | | | | (QoE, GPS, etc) to allow more |
| | | | | comprehensive map definition. |
| MetricsList | O | 0 . . . N | List | Mandatory field if EnableAccess |
| | | | | parameter is set to1. It defines the |
| | | | | set of application-specific metrics |
| | | | | that the Robot Control System may |
| | | | | share with the Radio Context Map |
| | | | | Service. Its content also depends on |
| | | | | the set of sensor installed on the |
| | | | | robot device. Example list include: |
| | | | | 1. GPS information |
| | | | | 2. QoE metrics |
| BaseStationIDs | M | 0 . . . N | Enumeration | Defines the list of Base Station IDs |
| | | | | (PCI) of interest |
| MapSettings | O | 0 . . . N | | Defines a set of |
| >SpatialGranularity | O | 1 | Integer | Defines the desired spatial |
| | | | | granularity of the coverage map. |
| | | | | (Optional Parameter) |
| >ProcessingFunction | O | 1 | String | Defines the specific processing |
| | | | | function to be applied on the |
| | | | | historical UE-specific collected |
| | | | | samples. |
| | | | | (Optional Parameter) |
| | | | | Example processing functions |
| | | | | include: |
| | | | | 1. Latest |
| | | | | 2. Average |
| ServiceInfo | O | 0 . . . N | Structured | This type represents the general |
| | | | | information of a MEC service and it |
| | | | | is defined as a subset of attributes |
| | | | | from the data type in [1] clause 6.2.2. |
| >serName | M | 1 | String | The name of the service. This is how |
| | | | | the service producing MEC |
| | | | | application identifies the service |
| | | | | instance it produces (see [1] clause |
| | | | | 6.2.2). |
| >serCategory | O | 0 . . . 1 | CategoryRef | A Category reference. (The category |
| | | | | resource is used to group product |
| | | | | offerings, service and resource |
| | | | | candidates in logical containers. |
| | | | | Categories may contain other |
| | | | | categories and/or product offerings, |
| | | | | resource or service candidates.) |
| | | | | (see [1] clause 6.2.2) |
| | | | | For the serCategory, the example |
| | | | | values include: |
| | | | | 1. “RNI” |
| | | | | 2. “Location” |
| | | | | 3. “Bandwidth Management” |
| >version | M | 1 | String | The version of the service (see [1] |
| | | | | clause 6.2.2). |

Table 1 relates to the ETSI MEC standard and, in some instances, particularly refers to the ETSI standardization document ETSI MEC ISG, “Mobile Edge Computing (MEC); Mobile Edge Platform Application Enablement,” ETSI, DGS MEC 011, July 2017 (referred to as [1]), which is hereby incorporated by reference herein.

If the optional EnableAccess field is enabled, the RCS 150 grants the Radio Context Map Service 160 a permit to access real-time information coming from ongoing communications. In this way, the Radio Context Map Service 160 would be able to provide more accurate Radio Context Maps to future requesters connecting to the same base station. This is done by enabling a dedicated communication session updating the Coverage Map database.

Upon receipt of the coverage map request, the RCMS 160 queries its database against the list of base stations and processes the information according to the incoming Request field ProcessingFunction, as shown at step S4, and then returns the respective coverage maps to the RCS 150, as shown at step S5. In embodiments, the response may include one or more of the attributes shown in Table 2 below.

TABLE 2
Response message attributes

| Attribute name | Qualifier | Cardinality | Data type | Description |
|---|---|---|---|---|
| ServiceID | M | 0 . . . N | URI | It Specifies the ID of the Radio |
| | | | | Context Map service providing the |
| | | | | response. |
| ResponseID | M | 1 | Enumeration | Defines the response ID |
| RequesterInfo | O | 0 . . . N | Structured | This type represents the general |
| | | | | information of a MEC application |
| | | | | requester, and it is defined as a |
| | | | | subset of attributes |
| >RequesterID | M | 0 . . . N | URI | ID of the Robot Control System |
| | | | | which started requesting the service |
| >RequestID | M | 0 . . . N | Enumeration | Defines the ID of the request this |
| | | | | response message is referring to |
| CoverageMap | M | 1 | Structured | Requested coverage map |
| | | | | information in exploitable data |
| | | | | format (e.g., JSON, CSV, etc. |
| | | | | Implementative detail which is out of |
| | | | | the scope of this document) |
| >Metadata | M | 0 . . . N | Structured | Collection of metadata |
| | | | | characterizing the coverage map. |
| | | | | This includes, but is not limited to, |
| | | | | the following information: |
| | | | | 1. Last temporal update |
| | | | | 2. URL |
| ServiceInfo | O | 0 . . . N | Structured | This type represents the general |
| | | | | information of a MEC service and it |
| | | | | is defined as a subset of attributes |
| | | | | from the data type in [1] clause 6.2.2. |
| >serName | M | 1 | String | The name of the service. This is how |
| | | | | the service producing MEC |
| | | | | application identifies the service |
| | | | | instance it produces (see [1] clause |
| | | | | 6.2.2). |
| >serCategory | O | 0 . . . 1 | CategoryRef | A Category reference. (The category |
| | | | | resource is used to group product |
| | | | | offerings, service and resource |
| | | | | candidates in logical containers. |
| | | | | Categories may contain other |
| | | | | categories and/or product offerings, |
| | | | | resource or service candidates.) |
| | | | | (see [1] clause 6.2.2) |
| | | | | For the serCategory, the example |
| | | | | values include: |
| | | | | 1. “RNI” |
| | | | | 2. “Location” |
| | | | | 3. “Bandwidth Management” |
| >version | M | 1 | String | The version of the service (see [1] |
| | | | | clause 6.2.2). |

Like Table 1, Table 2 also relates to the ETSI MEC standard and, in some instances, particularly refers to the ETSI standardization document ETSI MEC ISG, “Mobile Edge Computing (MEC); Mobile Edge Platform Application Enablement,” ETSI, DGS MEC 011, July 2017 (referred to as [1]).

Upon receipt of the requested information, the RCS 150 is now able to perform optimized orchestration decisions based on added-value information obtained by the Radio Context Map Service 160, as shown at step S6.

Finally, as shown at step S7, the RCS 150 sends appropriate control instructions to the robot device(s) 140 deployed on the field via the data plane, i.e. exploiting the existing mobile network communication channel. According to embodiments, the control instructions/commands may include, but not limited to, an optimized navigation plan, and/or off-loading instructions and/or strategy.

Embodiments of the present invention provide functionalities that can be applied during the bootstrap phase of the RCMS, or in case the coverage map of a requested base station is not available at the time of the Coverage Map request message (cf. step S3 in FIG. 3), in order to create a new entry into the Coverage Map Database, and populate its content with the corresponding information about the coverage map exploiting existing MEC services enter/or auxiliary information coming from the robot control system.

### Radio Context Map Creation and Update Based on Existing MEC Services

In accordance with an embodiment of the invention, for building the Radio Context Map, one way is to leverage the subscription services offered by both RNIS 170 and LS 180 within the MEC system 120 to periodically retrieve the network and location information specifying a certain periodicity (defining a time interval or, e.g., based on a set of possible events).

Embodiments of the invention aim at providing a radio context map including a mapping between each robot accurate location and the corresponding radio channel quality, e.g., in terms of receive signal level. Currently, MEC RNIS can access UE measurement reports that are sent by the UE to the serving gNB including the Reference Signal Received Power (RSRP) and the Reference Signal Received Quality (RSRQ) information of the primary (or serving) gNB, the secondary gNBs, which are employed for carrier aggregation, and other neighboring gNBs. Such information are generally adopted by the mobile network to ensure service continuity while the UE roams the network, over the related hand-over procedures.

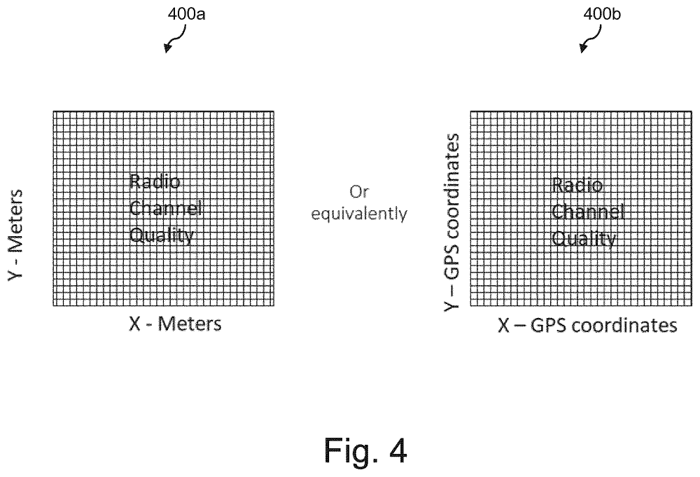

As hinted in FIG. 4, in the context of the present disclosure, a radio context map may be envisioned as a data structure, whose entries are in the simplest definitions tuples of the form (position, channel quality), where the former is given by the localization information derived by the LS function as depicted in FIG. 1, and the latter is given by the corresponding channel quality experienced by robots (or UEs, in general) at the same location, i.e., RSRP, RSRQ or similar indicators.

It is explicitly noted that there is no intrinsic limitation to the nature of the position information, which can be expressed in terms of relative coordinates (i.e. relative to the reference robot or some given location in the area), as shown in map 400a, or global coordinates, as shown in map 400b. The Robot Control System 150 suitably processes the available coverage radio map coordinates according to their nature. For instance, it may be provided that, whenever Global Navigation Satellite Systems (GNSS) coordinates are provided, the RCS 150 matches the position obtained via the sensors on-boarded on the robot device 140 and the corresponding absolute network-based position in order to retrieve the correct coverage map information. Moreover, the RCS 150 may enrich the granularity of the coverage information including RNIS-based information only by pushing the information exposed by the robot application (running within the MEC premises) to the RCMS 160. As robots can measure their radio context at any location along their trajectories, the resulting map will eventually have higher granularity compared to the one that is obtained when utilizing only the information that is available at the network side. This case will be described in greater detail further below.

According to the current 3GPP standard description (cf. ETSI GS MEC 012 V2.1.1 (2019-12) Multi-access Edge Computing (MEC); Radio Network Information API), to avoid continuously overloading the network, the UEs transmit measurement reports only in case of few and well-defined triggering events, specified in the RRC Connection Reconfiguration. Indeed, there is no practical way to trigger the measurement report of the receive signal level experienced by UEs from the RNIS side, which may be necessary for the purpose of creating a coverage map. For this reason, embodiments of the present invention provide mechanisms to increase the timeliness of the coverage map updates by leveraging on real-time robot-generated information.

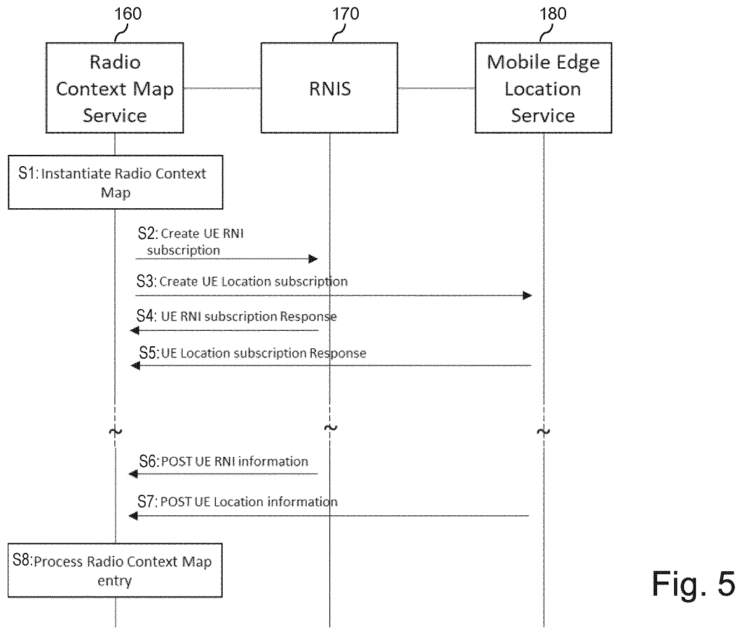

Before describing these mechanisms in detail, first, an embodiment of a radio context map creation procedure that is based only on network-originated information will be presented with reference to FIG. 5, depicting the respective message flow chart.

According to the illustrated embodiment, the radio context map creation procedure starts with the RCMS 160 instantiating an empty radio context map including a respective empty database, as generally shown at step S1 in FIG. 5.

After that, the RCMS 160 sends a Create UE RNI subscription request to the RNIS 170, as generally shown at step S2. Furthermore, the RCMS 160 sends a Create UE location subscription request to the MEC LS 180, as generally shown at step S3.

With respect to the Create UE RNI subscription request, the RNIS 170 acknowledges the request by sending a UE RNI subscription response, as shown at step S4. Furthermore, with respect to the Create UE location subscription request, the MEC LS 180 acknowledges the request by sending a UE Location subscription response, as shown at step S5.

After these initial request-response messages, the RNIS 170 posts UE RNI information to the RCMS 160, as shown at step S6. Likewise, the MEC LS 180 posts UE location information to the RCMS 160, as shown at step S7.

As shown at step S7, based on the received UE RNI and UE location information, the RCMS 160 processes each Radio Context Map entry by unpacking the information attributes and updating the corresponding entry in the Coverage Map DB. If no entry is available for a current location, then a new entry is created to store the current coverage information.

In particular, the RCMS 160 may be configured to compare the current UE

information incoming from the RNIS 170 and the MEC LS 180 against the available Coverage Map database. If any information at the current coordinates for the current BS is already included in the database, such information is overwritten.

However, given the finite accuracy of UEs localization (either via the network or via GNSS), according to an embodiment of the invention, it may be provided that the RCMS 160 matches the current location with the closest location available in the database if their Euclidean distance is smaller than a predefined threshold. Note that by setting a high threshold, it is more likely that new UE RNI and Location information generate a new Radio Context Map entry, thus resulting in a more dense map with less frequent updates on the already available measurements. On the contrary, a small threshold enables the Radio Context Map to be frequently updated at the cost of a lower granularity. According to an embodiment of the invention, this parameter may be configurable and may be fine-tuned according to the specific needs of the robotic tasks executed by the RCSs 150.

The Radio Context Map procedure guarantees that the radio context map is periodically updated (e.g. with a fixed or tunable periodicity) by concatenating the most recent channel quality data information for every visited locations. This feature enables the RCMS 160 to provide, in response to CoverageMapRequest Messages (cf. step S4 of FIG. 3), a Radio Context Map which meets heterogeneous RCS 150 requirements by applying ad-hoc processing functions while elaborating the raw data.

For example, the raw data collected by the RCMS 160 include per-base station information. Base station connectivity often overlap in space, therefore, an RCS 150 may be more interested in obtaining average spatial information condensing the spatial information into a unified map, regardless of the specific base station. Conversely, historical information could be condensed into an average quality values for each location point in the map, which can be more useful in scenarios characterized by highly variable channel conditions.

### Radio Context Map Creation Jointly With the Robot Application Metrics

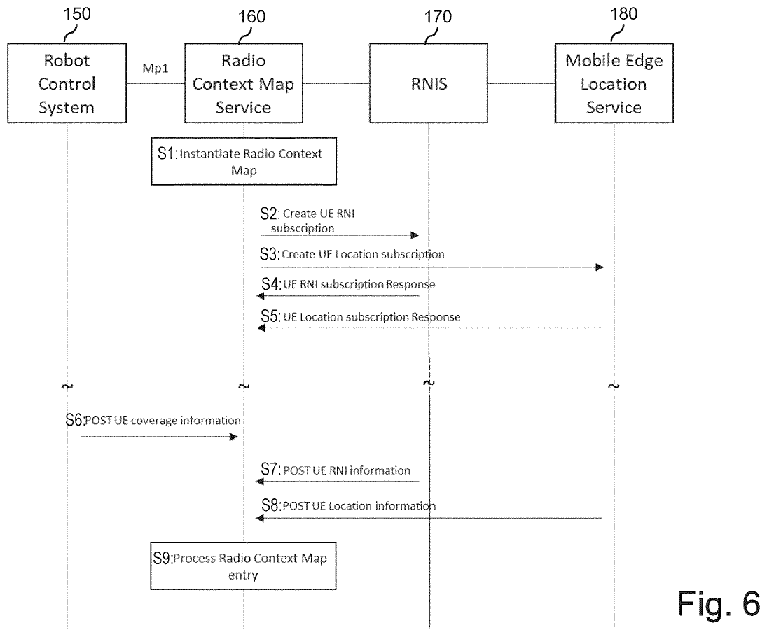

As already mentioned above, embodiments of the invention provide mechanisms that leverage on real-time robot-generated information to create a radio context map, thereby increasing the timeliness of the coverage map updates. FIG. 6 depicts an exemplary message flow of a procedure for creating and updating a radio context map jointly with the robot application metrics.

In this context, it is important to note that, by design, the RCMS 160 might store all available features at any given location, and expose the list of available features to the Robot Control System 150 during the Radio Map Request procedure (as described in connection with FIG. 1).

Further, it is worth pointing out that even the size of the tuple at each entry of the map can be changed by including additional complementary features to the ones related to channel quality, thus extending the scope of the present invention. Specifically, according to an embodiment, the invention provides a method to create/update the radio context map also including selected robot-originated information. In particular, the map may include other information collected locally from the robot by means of on-board sensors (e.g. GPS location, application QoE, etc.).

In addition, a report of the robot perceived radio quality, which can be collected from the robot applications (e.g., an alternative indication of receiving good or poor radio signals) may be also very helpful. This is especially true in cases where the radio channel conditions may change very fast, e.g. when adopting mmWave communications. As the method described in connection with FIG. 5 cannot support frequent (almost real-time) map updates of the radio context map information and does not enable deterministic updates, an embodiment of the invention relies on the robotic applications metrics to perform timely control of the robots. In this case, additionally, GPS information coming from the Robot Control System 150 and related robot devices can be exploited to complement the existing network-provided radio information (e.g., from the RNIS service 170 and the MEC LS 180).

An exemplary message flow chart of a Radio Context Map Creation procedure

including robot application metrics is shown in FIG. 6. It should be noted that a condition as shown in FIG. 6 arises whenever the RCS 150 has set the attribute “EnableAccess”, thereby stating that it can contribute to the updates of the coverage map with finer granularity samples.

In the following, the steps to create and update a Radio Context Map in the proposed RCMS 160 including robot-originated metrics are detailed with reference to FIG. 6. At first, like in the embodiment of FIG. 5 and as shown at step S1, the RCMS 160 instantiates an empty radio context map.

Steps S2-S5 also correspond to the respective steps of the embodiment of FIG. 5, i.e. the RCMS 160 sends a Create UE location subscription request to the RNIS 170 (step S2) and a Create UE RNI subscription request to the MEC LS 180 (step S3), wherein the RNIS 170 acknowledges the request by sending a UE RNI subscription response (step S4) and the MEC LS 180 acknowledges the request by sending a UE Location subscription response (step S5).

In contrast to the embodiment of FIG. 5 and as shown at step S6 of FIG. 6, the Robot Control System 150 is configured to post UE-related information to the RCMS 160. In addition, like in the embodiment of FIG. 5, the RNIS 170 posts UE RNI information to the RCMS 160, as shown at step S7, and the MEC LS 180 posts UE location information to the RCMS 160, as shown at step S8.

Based on the received information and as shown at step S9, the RCMS 160 processes each Radio Context Map entry by unpacking the information attributes and updating the corresponding entry in the Coverage Map DB. If no entry is available for the current location, then a new entry may be created to store the current coverage information.

According to an embodiment, the RCMS 160 may be configured to compare the current incoming UE information either generated by the network or by the RCS 150 against the available Coverage Map database. If any information at the current coordinates for the current BS is already included in the database, such information may be overwritten or merged, taking into account the finite accuracy of the localization procedure. Further details on the processing have already been described above in connection with the embodiment of FIG. 5 and can be applied likewise in connection with the embodiment of FIG. 6.

The present invention provides a generic approach, which is not limited to the robotic use cases, but generally supports any MEC application that may require to acquire radio quality related information in a given area. As examples, embodiments of the invention can be also applied to the following Hereinafter two possible uses cases, in which embodiments of the present invention can be suitably applied, are described in some more detail. However, it should be noted that the described use cases are merely illustrative and that a variety of further use cases can be envisioned.

### Connected Vehicles

The development of Connected, Cooperative and Automated Mobility (CCAM) applications within the 5G network architecture is fostering the spread of connected vehicles on the road. The expected agile and distributed deployment and management of such applications that may require accurate knowledge of the radio quality experienced by each connected vehicle, which in turn depends on several factors such as their instantaneous speed, location, channel fading and so forth. For instance, with the advent of autonomous vehicles, such applications may perform emergency path planning to give way to incoming emergency vehicles from the drivers' back, enhancing their overall situation awareness.

In this scenario, the RCMS as described in the present disclosure in accordance with embodiments of the invention, may leverage on the high mobility and ubiquity of vehicles to build a dense coverage map, which benefits from frequent radio quality updates thanks to the high likelihood of occurrences of triggering events (as those specified by 3GPP standards), and corresponding measurement reports by each connected vehicle, thereby allowing for the generation of up-to-date information at the RCMS in a transparent manner.

5G-Enabled Drones for the First Responders (e.g. Fire Extinction, Emergency)

Embodiments of the present invention will be also very useful for emergency scenarios, in which drones remotely controlled through 5G networks are used to enable an efficient first responder action on the field, by allowing quick access to the emergency area, creating a better situational awareness, and facilitating the exchange of information among all stakeholders in the scene (e.g., multiple teams, local and remote command and control points) so as to provide real time aerial support and precision targeting support for ground and air first responder forces.

Typically in such emergency scenarios, the drones are flying and exploring an unknown or remote rural area (e.g., in a forest), where no RAN related information is available. However, all drones and all teams like fire fighters need 5G connections to perform their tasks and, moreover, a good knowledge about the 5G coverage and radio quality of this area will be quite helpful for them to decide and navigate towards the right locations and plan the paths to those emergence spots. The radio connections and their signal quality can change dynamically in such situations, as the radio quality varies depending on the mobility of the fire fighters, their location, obstacles, fires, as well as the height and velocity of the drones, therefore a real time update of the RAN context information that may be required.

In such scenarios, the RCMS as described in the present disclosure in accordance with embodiments of the invention, can leverage on the drones and the UE devices of all fire fighter teams to build such a radio map, which benefits from frequent radio quality updates provided by each connected devices/drones or from the applications, thereby generating up-to-date RAN information. And in return, the RCMS services can provide such up-to-date radio information to all involved entities, to help them make prompt decisions on where to move and which paths to take, based on the knowledge of the current radio quality of a certain location provided by the RCMS.

In some cases, the drones can also install base station functions to provide 5G coverage. In such scenarios, the radio context can be even much more dynamic and thus the applications may require more frequent update and storage of such a radio map to be provided by the RCMS.

To summarize important aspects, according to embodiments the present invention provides methods and systems to enable connectivity-aware UE (e.g. robot devices) optimizations in MEC-enabled scenarios comprising one or more of the following steps/components:
1. Registration and Running the RCMS 180 on the MEC platform 122;
2. RCMS 180 subscribes to location and radio information from existing MEC services (e.g. MEC RNIS 170 and LS 180);
3. Optionally, the robotic application or any other third party MEC applications may send selected application-related metrics to the RCMS 180 upon configuration;
4. Building the Radio Context Map by collecting the information collected at points 2) and optionally 3) and then filtering and consolidating the information from multiple UEs, then combining various types of information to generate the map.
5. Sharing the Radio Context Map information with other MEC applications (e.g., RCSs 150 or third-party entities).

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of providing radio context map information to a Multi-Access Edge Computing; (MEC) application that is deployed at a MEC host and manages a 5G or Beyond 5G (B5G)-enabled network device, the method comprising:
registering and running a Radio Context Map Service; (RCMS), on an MEC platform of the MEC host;
subscribing, by the RCMS, to location and radio information from existing MEC services of the MEC platform;
creating and updating, by the RCMS, a radio context map by processing location and radio information received from the subscribed MEC services and by combining the received location and radio information with additional application related context information provided through the MEC application or any other MEC application deployed at the MEC host; and
providing, by the RCMS, the radio context map to the MEC application.

2. The method according to claim 1, wherein the MEC application is a Robot Control System (RCS-) configured to manage operation of a 5G or B5G-enabled robot device.

3. The method according to claim 1, further comprising:
sharing the radio context map with other MEC applications and/or MEC services.

4. The method according to claim 1, wherein the RCMS subscribes to and receives network-based information from an MEC Radio Network Information Service (RNIS) and/or from an MEC Location Service MEC (LS).

5. The method according to claim 4, wherein the network-based information the RCMS retrieved through the RNIS includes at least one of measurement information related to a user plane, information related to specific UEs connected to radio node(s) associated with the MEC host, and changes in information related to UEs connected to the radio node(s) associated with the MEC host, UE context and related radio access bearers.

6. The method according to claim 4, wherein the network-based information the RCMS retrieved through the MEC LS includes at least one of a position of radio node(s) associated with the MEC host, a position of UEs connected by radio node(s) associated with the MEC host, and a list of UEs located in or moving to/from a particular geographical area.

7. The method according to claim 1, wherein the RCMS creates and updates the radio context map by additionally including information collected by the MEC application, which collects the information locally via on-board sensors by the 5G or B5G-enabled network devices and/or by further 5G or B5G-enabled network devices deployed in a coverage area of the radio node(s) associated with the MEC host.

8. The method according to claim 1, wherein the RCMS stores a collected set of historical real-time RAN information over a specified time period in a geographical area including a set of radio node(s) associated with the MEC host.

9. The method according to claim 1, wherein the MEC application uses the radio context map to generate and send via an existing mobile network communication channel appropriate control instructions to the 5G or B5G-enabled network device managed by the MEC application.

10. A system for providing radio context map information to a Multi-Access Edge Computing (MEC) application that is deployed at a MEC host and manages a 5G or Beyond 5G (B5G)-enabled network device, the system comprising:
a Radio Context Map Service (RCMS), registered at and running on an MEC platform of the MEC host, the RCMS being configured to:
subscribe to location and radio information from existing MEC services of the MEC platform,
generate and update a radio context map by processing location and radio information received from the subscribed MEC services and by combining the received location and radio information with additional application related context information provided through the MEC application or any other MEC application deployed at the MEC host, and
provide the radio context map to the MEC application.

11. The system according to claim 10, wherein the MEC application is a Robot Control System (RCS), configured to manage operation of a 5G or B5G-enabled robot device.

12. The system according to claim 10, wherein the RCMS is configured to receive network-based information from an MEC Radio Network Information Service, (RNIS), and/or from an MEC Location Service MEC (LS).

13. The system according to claim 10, wherein the RCMS is further configured to create and update the radio context map by additionally including information collected locally via on-board sensors by the 5G or B5G-enabled network devices itself and/or by further 5G or B5G-enabled network devices deployed in a coverage area of the radio node(s) associated with the MEC host.

14. The system according to claim 10, wherein instances of the MEC application run as virtual machines and/or containers within the MEC platform.

15. The system according to claim 10, wherein connectivity between the 5G or B5G-enabled network device and the MEC application is provided by the 5G or B5G network data plane exploiting a dedicated User Plane Function (UPF), deployed within the MEC system.
